(19) United States
(12) Patent Application Publication
(10) Pub. No.: US 2016/0368298 A1
(43) Pub. Date: Dec. 22, 2016

(54) POST-PRODUCTION COATINGS AND INCORPORATION PROCESSES FOR PLASTIC

(71) Applicant: Joel Michael Vaughn, Groveport, OH (US)

(72) Inventor: Joel Michael Vaughn, Groveport, OH (US)

(21) Appl. No.: 15/186,760

(22) Filed: Jun. 20, 2016

Related U.S. Application Data
(60) Provisional application No. 62/181,282, filed on Jun. 18, 2015.

(51) Int. Cl. B41M 5/26

(52) U.S. Cl. CPC B41M 5/267

(57) ABSTRACT

A method of producing incorporated marks into thermoplastics and the apparatus resulting from the method. The marking material may be applied as a coating via a number of techniques, and then incorporated into the plastic via a variety of heat sources, including a laser. The incorporated coating components may have features such as color that contrasts with the color of the surrounding substrate surface material, and/or may contain environmental indicators or tracer materials. A laser may be used to heat the coating and cause the plastic structure's surface to soften, thereby permitting the components of the coating to become physically encompassed in the plastic. Surrounding coating and/or plastic may be removed using a stronger laser or other energy-application apparatus.

### CROSS-REFERENCES TO RELATED APPLICATIONS

This application claims the benefit of U.S. Provisional Application No. 62/181,282 filed Jun. 18, 2015. The prior application is hereby incorporated by reference.

### STATEMENT REGARDING FEDERALLY-SPONSORED RESEARCH AND DEVELOPMENT

(Not Applicable)

### THE NAMES OF THE PARTIES TO A JOINT RESEARCH AGREEMENT

(Not Applicable)

### REFERENCE TO AN APPENDIX

(Not Applicable)

### BACKGROUND OF THE INVENTION

The present invention relates generally to the field of marking systems, and, more specifically, to the marking of plastics.

Marking materials is a common method to add serial numbers, logos, barcodes, and other information. Additionally, marks are sometimes used as a decorative feature or as an indicator. Marking materials adds a lot of value to manufactures, vendors, and end users.

The marking of plastic substrates is commonly accomplished with paints and other coatings applied to the substrate surface, engraved features into the substrate surface, laser engraving, laser charring, and laser foaming techniques. Some marking methods use additives added to the bulk plastic that enhance laser marking for higher contrast.

It can be difficult for paints and other coatings to adhere to some plastics, such as Polyoxymethylene and Polytetrafluoroethylene. Paints that do adhere initially can be scratched off by scraping or sliding during manufacturing, packaging and shipping, and some paints cannot withstand certain chemical baths that affect adhesion or remove the paint due to mechanical removal combined with reduced adhesion. For more resilient and permanent marks, laser marking techniques are employed.

In order to laser mark some plastics, manufactures include additives with the plastic in bulk during manufacture of the plastic component (see U.S. Pat. No. 6,022,905 and U.S. Pat. No. 6,693,657, which are incorporated herein by reference). This typically results in a black mark on a white plastic substrate or white marks on darker plastic substrates. By adding materials to the bulk plastic prior to formation of the plastic component, the plastic's structural integrity may be compromised for certain applications. The additive may affect the original polymer's strength, melting point, chemical resistance, ultraviolet light (UV) sensitivity, and other characteristics. Additionally, there is not a known technique to add color, because most conventional marking systems depend upon charring for black marking and foaming for white marking.

For certain applications, the material that is desirably marked may have already been used to make a product. If the additives were not added into the bulk ahead of time, then a high contrast mark is no longer possible using the above-referenced marking methods.

Therefore, there is a need for a non bulk additive for the use of marking plastics permanently.

### BRIEF SUMMARY OF THE INVENTION

In one aspect, a plastic substrate is coated with an additive. The additive may contain micronized powders of any number of compounds or combinations thereof.

In another aspect, a plastic substrate is coated with an additive. The additive may contain nano sized powders of any number of compounds or combinations thereof.

In one aspect, a plastic substrate is coated with an additive. The additive may be a film of any number of compounds or combinations thereof that can be micronized by a laser or other energy-application, including without limitation, electric field, magnetic field, heated object, mechanical abrasion, and other energy-application means.

In another aspect, a plastic substrate is coated with an additive. The additive may be a film of any number of compounds or combinations thereof that can be broken down to nano sized particles by a laser or other energy application.

In yet another aspect, a plastic substrate may be coated with paint. The paint can then be partially, or fully integrated with the plastic substrate by a laser or other energy-application, including without limitation, hot liquid, hot air, or a heated object.

In another aspect, a plastic may be coated. Upon integration into the plastic, the coating may change colors. For example, white to black, or black to red.

In one aspect, a plastic substrate is coated with an additive. The additive may be incorporated into the plastic with a light source such as a laser or other energy-application, including without limitation, hot liquid, hot air, or a heated object.

In another aspect, a plastic substrate is coated with an additive. The additive may be incorporated into the plastic with a light source such as a laser, while other portions of the additive may be removed or broken down by a more powerful light source, such as a laser.

These and other features, aspects and advantages of the present invention will become better understood with reference to the following drawings, description and claims.

### BRIEF DESCRIPTION OF THE SEVERAL VIEWS OF THE DRAWINGS

FIG. 1 is a photograph of a coating in accordance with an embodiment of the present invention on a substrate; and

FIG. 2 is a photograph of a coating that has been processed in accordance with an embodiment of the present invention on a substrate.

FIG. 3 is a photograph of a coating that has been processed in accordance with an embodiment of the present invention.

FIG. 4 is a photograph of a coating that has been processed in accordance with an embodiment of the present invention.

FIG. 5 is a photograph of a coating that has been processed in accordance with an embodiment of the present invention.

FIG. 6 is a photograph of a coating that has been processed in accordance with an embodiment of the present invention.

FIG. 7 is a schematic top view illustrating a plastic substrate made according to the present invention.

FIG. 8 is a schematic side view in section illustrating the embodiment of FIG. 7 through the line 8-8, and illustrating how the coating components are incorporated into the surface of the substrate.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Provisional Application No. 62/181,282 filed Jun. 18, 2015 is incorporated in this application by reference. The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Various inventive features are described below that can each be used independently of one another or in combination with other features.

Broadly, embodiments of the present invention provide a process and materials for use in marking on plastics, and produce the marked product itself. According to the present disclosure, a coating may be applied to a plastic substrate, where the plastic substrate is made of any plastic including, without limitation, polyethylenes, polyethylene terephthalate, polyurethanes, polypropylene, polyvinyl chloride, polytetrafluoroethylene, nylon, acrylic, polyimide, polycarbonate, polyoxymethylene, acrylonitrile-butadiene-styrene, polystyrenes, and other known plastics. The preferred plastics are thermoplastics and may include rubber and any other known plastic material. The coating may include one or more pigments and/or dyes. The pigments may include, without limitation, iron oxides, cobalt oxides, lead oxides, metal oxides, carbon black, clays, carbonates, ochres, and other known pigments. The dyes may include, without limitation, acid dyes, basic dyes, salts, direct dyes, mordant, reactive dyes, vat dyes, disperse dyes, sulfur dyes, and other known dyes. The coating may include one or more carriers, and the carriers may include, without limitation, ethanol, isopropanol, chloroform, acetone, water, ethers, alcohols, hexane, xylene, heptane, pentane, benzenes, and other known carriers. The coating may include one or more binders, and the binder may include, without limitation, polyethylene glycol, styrenes, acrylics, cellulose, and other known binders. The coating may contain one or more dispersants, and the dispersant may be, without limitation, detergents, emulsifiers, and other known dispersants. The coating may include one or more low transmittance materials for one or more wavelengths, such as 10630 nm, 1064 nm, 2.6-4.0 μm, 4.8-8.3 μm, 1.0-3.0 μm, ultraviolet, etc. The low transmittance materials may include alumina, iron oxides, zinc oxide, and other materials. The coating may include one or more high-transmittance materials for a given wavelength, including, but not limited to, the wavelengths listed above. The high transmittance materials may include antimony tetroxide, chromic oxide, cobalt oxides, iron oxides, magnesium oxide, and other materials.

The coating may be transparent. The coating may be designed to fade due to, but not limited to, time, exposure to environmental conditions such as light, humidity, and other factors. The coating may be color changeable via chemical changes induced by a light or other energy source such as, but not limited to, a laser, a diode, sunlight, ultra violet light, and other energy sources. The coating may contain one or more environmental indicators including, but not limited to, humidity, temperature, chemical detection, and other indicators, where an indicator may, but does not necessarily, change color, light responsiveness, chemically change, physically expand, physically shrink, or otherwise become modified by environmental factors. The incorporated material may act as an abrasion or material wear indicator.

The plastic may contain one or more polymer. The plastic may also or alternatively contain one or more additives including, but not limited to, pigments, emulsifiers, high or low transmittance materials for a given wavelength, metallic particles, and other additives. The plastic may have a predetermined transmittance to a given wavelength of light.

There may be a pretreatment of the plastic including, but not limited to, surface roughening, polishing, flame treatments, pre-coating to increase wettability, washing, plasma, and other pretreatments.

The coating can be applied to the plastic via a number of methods including, but not limited to, pad printing, a wet spray, powder spray, electrostatic spray deposition, electrostatic transfer, electrostatic dipping, dry dipping, wet dipping, roller, inkjet, thermal transfer, pen, marker, and any other known coating process.

More than one coating may be applied to produce a resulting mark of varying color, color that varies with thickness, or other attributes. For example, in the instance of applying via a printer, a color photo could be produced.

The coating, which may be a plurality of particles in a carrier that evaporates, may be incorporated into the substrate's surface no more than a predetermined amount using a heat source such as, but not limited to, a hot iron, flame, laser, diode, lamp, oven, hot bath, and other known heat and/or other energy sources. The predetermined amount that the coating may be incorporated into the substrate's surface may be about 2.0 mm, but may be less or more depending upon the substrate's thickness. For example, a plastic component that is 5.0 mm thick may have coating material incorporated only 1.0 mm deep into the surface. Furthermore, a plastic component that is 5.0 cm thick may have coating material incorporated 3.0 mm deep into the surface. As shown schematically in FIGS. 7 and 8, the coating includes a plurality of particles 20 that are incorporated into the surface of the substrate 22 in the shape of a star 24 and a rectangle 26. When viewed from the side, as in FIG. 8, and particularly the magnified portion thereof, the particles 20 extend, to varying degrees, into the substrate's surface.

The coating of any embodiment may be incorporated into the substrate via pressure greater than atmospheric pressure in another material, including, but not limited to, air, inert gas, reactive gases, liquids, and other materials. Thus, the incorporation of the coating material into the plastic substrate's surface may be by any acceptable mechanism using thermal energy to melt the plastic substrate's surface, or may alternatively warm the substrate's surface without melting. For example, one may thermally expand the substrate's surface without melting, which causes the coating to be incorporated into small openings in the substrate, thereby capturing the coating upon cooling. Still further, mechanical energy may be used to press the coating into the plastic substrate's surface, and a coating may be injected into the substrate's surface by any other acceptable substitute. The use of a laser as described below is advantageous due to many factors, including the ability to control precisely the application of the energy to a specific location and the ability to avoid other locations, along with the ability to control the quantity of energy imparted using the laser.

There may be one or more post-incorporation treatments such as, but not limited to, washing away any non-ablated material, over coating, additional incorporation steps, flame, plasma, painting, further part finishing or material removal, mechanical abrasion, grinding, sanding, high pressure water, and any other acceptable treatments.

The coating may be applied first to the entire substrate, or only to a portion of the surface of the substrate. A subsequent step is that one or more regions of that coating are incorporated into the substrate. In order for the coating to be “incorporated into” the substrate, at least a portion of the material of the coating must be physically located beneath the outer surface of the plastic substrate. One example of incorporating the coating is a coating of fine particles, many of which are heated to locally melt the plastic substrate's surface, thereby permitting the particles to sink into the plastic substrate's surface. Once the plastic substrate cools, all of the particles that are incorporated into the substrate are mechanically bound to the plastic at the surface. Some particles may be completely submerged within the plastic, some may be partially submerged, and others may only contact the plastic. Nevertheless, the particles are incorporated sufficiently to retain them in the plastic. This is illustrated in FIGS. 7 and 8.

Once incorporation has been effected in some or all regions of the substrate, a next step may be to remove the coating from regions where the coating is not desired. This may be in regions where the coating has been incorporated into the substrate, regions where the coating has not been incorporated, or both. For the one or more regions that are to be uncoated (where the substrate is exposed) by the time of final use, the coating in these regions may be actively removed via deliberate removal of the coating only, removal of the underlying plastic, or removal of both the coating and the plastic. Removal may be effected by ablation, mechanical abrasion, or any other known manner of removing the coating and/or the plastic. It is also possible to leave any coating on the substrate so that any non-incorporated coating material will be removed incidentally during subsequent processing, handling, shipping or any other time prior to final use of the substrate. For example, normal wear during subsequent handling may remove most or all of the unincorporated coating.

The incorporation of the coating into the plastic substrate may result in a shrinking, expansion, or no net effect on the plastic. The ablation or other removal may remove plastic to maintain a backup topography for traceability if the incorporated material is removed. The desired removal is only what is necessary to make the sought-after incorporated coating stand out, visually or using visually-analogous (e.g., video camera using software to analyze the pixels, etc.) from the area where removal has occurred.

Markings according to the description herein may have uses in laboratory equipment, laboratory methodologies, medical equipment, tracking and traceability, marketing, tamper resistant, tampering indicator, etc.

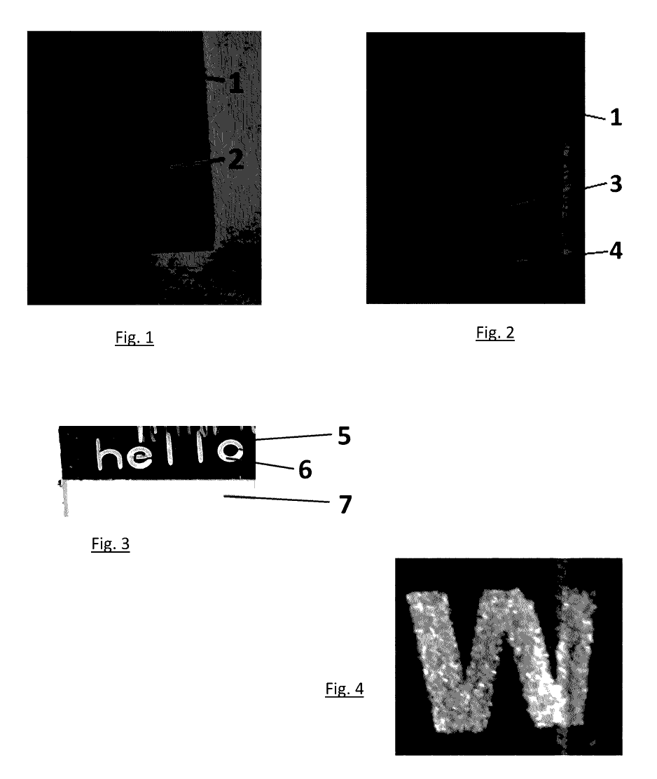

Referring now to the example shown in FIG. 1, a coating 2 containing a black pigment has been applied to a Polyoxymethylene substrate strip 1, which is white or at least much lighter in contrast to the coating 2. The colors are not critical, but visibility, such as by using the human eye, video equipment combined with software, or any other technology for receiving the information contained in the remaining, marking coating, must be retained. Visibility is preferably caused, and/or enhanced, by contrasting colors and/or levels of lightness and darkness. Coating of the substrate can be carried out by any conventional coating process, including any of the processes described herein or known by the person of ordinary skill in the technology.

As shown in FIG. 2, the coating 2 has been removed via laser from select regions or areas 3 on the substrate 1 of FIG. 1. The coating 2 that remains has been incorporated into the polyoxymethylene substrate 1 in select regions or areas 4 via a laser using less intensity (lower energy) than was used on the areas 3 that were ablated to remove the coating 2. The coating 2, when left in the incorporated areas 4 in a deliberate pattern, creates an identifiable mark on the substrate 1 that remains even after rubbing the areas 3 and 4 and subjecting the entire substrate 1 to multiple hot chemical baths. In the embodiment of FIG. 1, the coating was made of Fe₃O₄ and isopropanol and was hand-applied to the substrate. The person of ordinary skill will understand from the description herein that there are many other ways of carrying out the described process of coating the substrate, incorporating the coating and removing the coating in addition to those described.

The coating 2 shown in FIG. 1 and described above may alternatively be applied to the substrate 7 in a manner that causes the shape of the applied coating to be the design of the final incorporated marking. This is the case shown in FIG. 3 where the means of applying the coating 5 is sufficiently precise in its ability to coat some areas 5 and not coat other areas 6. In such an alternative to the method described in relation to FIGS. 1 and 2, no removal of any portion of the coating 5 is necessary. Therefore, only the incorporation step is carried out after the coating step, and ablation of the coating material is unnecessary. Ablation or other removal may be used to “touch up” the coating, but it is contemplated that the removal step is unnecessary in some circumstances. It is also contemplated to apply the coating in a manner that results in a partially complete mark, where a portion of the coating may still need to be ablated or otherwise removed. An example of this includes a black emblem and a black box applied as coatings to a substrate. The emblem coating portion may be entirely incorporated into the material of the substrate, and the black box coating portion may be partially incorporated into the substrate, and partially ablated to remove enough of the coating to produce, by the shape of the remaining coating, marking indicia: for example a serial number. In another example, portions of the black box may be ablated prior to incorporation of the emblem portion of the coating and then the method can include the step of leaving the remaining material of the black box coating portion un-ablated. In another example the box may be incorporated into the substrate and later portions ablated. In yet another example the emblem portion of the coating may be blue and the box portion of the coating may be black. In such an example, portions of the box may be partially ablated to remove the coating at numerous small and closely-spaced points to create a gray scale marking. In another example, portions of the incorporated black box may be ablated along with some underlying substrate material. In yet another example, a portion of the black box may be incorporated into the underlying substrate material while another portion of the black box is not incorporated. The non-incorporated region of the coating may then be removed via, but not limited to, abrasion, chemical removal, compressed air, high pressure water, or any other means of removing the unincorporated coating portion. In another example, the coating may be applied and incorporated simultaneously via a hot stamp.

As to the specific example shown in FIGS. 1 and 2, the black coating 2 may be submicron Fe₃O₄ on an acetal plastic substrate. The incorporated portion of the coating 4 in FIG. 2 was carried out with a 20 watt CO₂ laser (10.6 um) at 6.0% power. The ablated coating in FIG. 2 was carried out with a 20 watt CO₂ laser (10.6 um) at 12% power. During the incorporation step the laser melts the surface layer of the plastic locally where the laser strikes and the coating is incorporated into the melted plastic. During the ablation step the laser sufficiently heats the plastic locally where the laser strikes to combust the underlying plastic in a volatile manner, thereby removing the coating in the process.

In the example shown in FIG. 3, a piece of polypropylene was used as the substrate 7. Iron oxide was incorporated as a black patch coating 5 with a 20 watt CO₂ laser (10.6 um) at 10% power. If the coating may be applied precisely, no further step to remove portions of the coating is necessary. However, in the embodiment shown in FIG. 3, a portion of the coating 5 was removed from the areas 6 with a 15 watt YAG laser (1064 nm) to spell out the word “hello”.

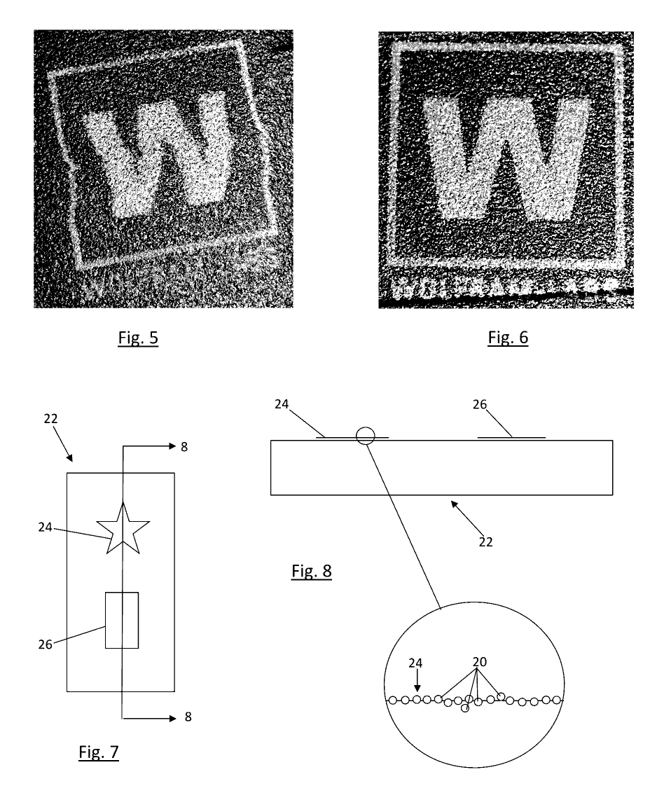

In FIGS. 4, 5, and 6 yellow, green and red coating components were incorporated into a black plastic, thereby resulting in different contrasting colors between the substrate surface and the incorporated components. FIGS. 4-6 show that colored coating components that contrast with the substrate, but do not contrast as much as black and white, may be used in the invention.

In yet another example, not shown, white aluminum oxide may be incorporated into black ABS plastic and blue, green, yellow and red pigments may be incorporated into white polypropylene. Other color combinations are contemplated.

In another example, a conventionally painted plastic part has a portion of a paint layer that is in contact with the plastic incorporated within the plastic, while the upper layer of paint, which is not in contact with the plastic surface, remains unincorporated. Overall adhesion of the paint is improved, along with a permanent underlying mark which has been incorporated into the plastic part.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method of marking a surface of a plastic substrate, the method comprising:
(a) coating at least a portion of the surface of the plastic substrate; and
(b) applying energy to at least a first region of the coating, thereby incorporating at least a portion of the coating in the first region into the surface of the plastic substrate.

2. The method in accordance with claim 1, wherein the step of applying energy comprises conveying thermal energy to at least the coating in the first region to soften the plastic substrate's surface.

3. The method in accordance with claim 2, wherein the step of applying energy comprises striking at least the coating in the first region with a laser of a first amount of energy.

4. The method in accordance with claim 3, further comprising applying energy to at least a second region of the coating, thereby removing at least some of the coating from the second region.

5. The method in accordance with claim 3, wherein the step of applying energy comprises striking at least the coating in said second region with a laser of a second amount of energy that is greater than the first amount of energy.

6. The method in accordance with claim 1, wherein the step of applying energy to the first region comprises striking at least the coating in the first region with a laser of a first wavelength.

7. The method in accordance with claim 6, further comprising applying energy to at least a second region of the coating, thereby removing at least some of the coating from the second region.

8. The method in accordance with claim 7, wherein the step of applying energy further comprises striking at least the second region with a laser of a second wavelength that is different than the first wavelength.

9. The method in accordance with claim 7, wherein the second region of the coating is separate from the first region.

10. The method in accordance with claim 7, wherein the first region at least partially overlaps with the second region.

11. A method of marking a surface of a plastic substrate, the method comprising:
(a) coating at least a portion of the surface of the plastic substrate; and
(b) striking at least a first region of the coating with a laser of a first amount of energy, thereby incorporating at least a portion of the coating in the first region into the surface of the plastic substrate.

12. The method in accordance with claim 11, further comprising the step of striking at least a second region of the coating with a laser of a second amount of energy that is greater than the first amount of energy, thereby removing at least some of the coating from said second region.

13. The method in accordance with claim 12, wherein the second region of the coating is separate from the first region.

14. The method in accordance with claim 12, wherein the first region at least partially overlaps with the second region.

15. The method in accordance with claim 11, wherein the plastic substrate is a thermoplastic.

16. A plastic substrate having a surface, the substrate comprising:
(a) at least a first, exposed portion of the surface; and
(b) at least a second portion of the surface having a coating incorporated into the plastic substrate, wherein the coating incorporated into the surface of the plastic substrate contrasts visibly with the exposed first portion of the surface of the plastic substrate.
